(19) United States
(12) Patent Application Publication
(10) Pub. No.: US 2023/0228239 A1
(43) Pub. Date: Jul. 20, 2023

(54) HYDRAULIC POWER GENERATION DEVICE

(71) Applicant: TOYOTA JIDOSHA KABUSHIKI KAISHA, Toyota-shi (JP)

(72) Inventors: Masashi SHIBATA, Toyota-shi (JP); Akira HANAMAKI, Toyota-shi (JP); Hideyuki MURAYAMA, Seto-shi (JP)

(73) Assignee: TOYOTA JIDOSHA KABUSHIKI KAISHA, Toyota-shi (JP)

(21) Appl. No.: 18/083,942

(22) Filed: Dec. 19, 2022

(30) Foreign Application Priority Data
Jan. 14, 2022 (JP) 2022-004177

(51) Int. Cl. F03B 11/00

(52) U.S. Cl. CPC F03B 11/00; F05B 2220/706; F05B 2260/402; F05B 2260/40311

(57) ABSTRACT

A hydraulic power generation device includes a water turbine disposed in a waterway, a drive shaft that extends to one side from the water turbine a first generator, a second generator, and a conveying mechanism configured to convey rotation of the drive shaft to an input shaft of the first generator and an input shaft of the second generator. The water turbine is configured to rotate along with the water turbine.

### CROSS-REFERENCE TO RELATED APPLICATION

This application claims priority to Japanese Patent Application No. 2022-004177 filed on Jan. 14, 2022, incorporated herein by reference in its entirety.

### BACKGROUND

### 1. Technical Field

The technology disclosed in the present specification relates to a hydraulic power generation device. In particular, the technology disclosed in the present specification relates to a hydraulic power generation device including a first generator and a second generator.

### 2. Description of Related Art

Japanese Unexamined Patent Application Publication No. 2006-296056 (JP 2006-296056 A) discloses a hydraulic power generation device that includes a first generator situated on one side of a water turbine and a second generator situated on the other side of the water turbine. In the hydraulic power generation device, a first generator is situated on one side of a waterway through which water flows, and a second generator is situated on the other side of the waterway.

### SUMMARY

The hydraulic power generation device disclosed in JP 2006-296056 A is disposed straddling the waterway. Accordingly, in the hydraulic power generation device, the length of a drive shaft is changed in accordance with the width of the waterway. Further, the hydraulic power generation device requires space for disposing the generator on both sides of the waterway. That is to say, the degree of freedom in layout is reduced in the hydraulic power generation device disclosed in JP 2006-296056 A. The present specification provides technology for improving the degree of layout freedom in a hydraulic power generation device that includes a first generator and a second generator.

A first aspect of the present disclosure is a hydraulic power generation device. The hydraulic power generation device includes a water turbine disposed in a waterway, a drive shaft that extends to one side from the water turbine, a first generator, a second generator, and a conveying mechanism configured to convey rotation of the drive shaft to an input shaft of the first generator and an input shaft of the second generator. The water turbine is configured to rotate along with the water turbine.

In the first aspect, rotation of the drive shaft extending to one side from the water turbine is conveyed to the input shaft of the first generator and the input shaft of the second generator by the conveying mechanism. Thus, the first generator and the second generator can be disposed on one side of the water turbine. Accordingly, the degree of freedom of layout of the hydraulic power generation device disclosed in this specification can be improved.

In the first aspect, the conveying mechanism may be configured to convey the rotation of the drive shaft to the input shaft of the first generator and the input shaft of the second generator, by performing step-up of the rotation of the drive shaft.

In the first aspect, the conveying mechanism may include at least one driving rotor fixed to the drive shaft, a first driven rotor fixed to the input shaft of the first generator and linked to the at least one driving rotor, and a second driven rotor fixed to the input shaft of the second generator and linked to the at least one driving rotor.

In the first aspect, the at least one driving rotor may include a common rotor linked to both the first driven rotor and the second driven rotor.

In the first aspect, the common rotor may be a bevel gear.

In the first aspect, the input shaft of the first generator and the input shaft of the second generator may each be orthogonal to the drive shaft.

In the first aspect, the input shaft of the first generator and the input shaft of the second generator may be disposed concentrically.

In the first aspect, a rotation direction of the input shaft of the first generator as viewed from a drive shaft side and a rotation direction of the input shaft of the second generator as viewed from the drive shaft side are the same as each other.

In the first aspect, the drive shaft may extend in a vertical direction from the water turbine.

In the first aspect, the drive shaft may extend downward following the vertical direction from the water turbine, and the first generator and the second generator may be situated downward from the waterway.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a hydraulic power generation device 10a according to a first embodiment;

FIG. 2 is a front view of a hydraulic power generation device 10b according to a second embodiment;

FIG. 3 is a front view of a hydraulic power generation device 10c according to a third embodiment;

FIG. 4 is a plan view of a hydraulic power generation device 10d according to a fourth embodiment; and

FIG. 5 is a plan view of a hydraulic power generation device 10e according to a fifth embodiment.

### DETAILED DESCRIPTION OF EMBODIMENTS

In an embodiment of the present technology, the conveying mechanism may convey rotation input from the drive shaft to the input shaft of the first generator and the input shaft of the second generator, by performing step-up of the rotation input from the drive shaft. According to such a configuration, the conveying mechanism can have a function of distributing the rotation of the drive shaft and a function of stepping up the rotation speed. As a result, the degree of freedom in the layout of the hydraulic power generation device can be improved as compared to a configuration in which each function is provided separately.

According to an embodiment of the present technology, the conveying mechanism may include at least one driving rotor fixed to the drive shaft, a first driven rotor fixed to the input shaft of the first generator and linked to the at least one driving rotor, and a second driven rotor fixed to the input shaft of the second generator and linked to the at least one driving rotor. According to such a configuration, the rotation of the driving rotor can be conveyed to the first generator via the first driven rotor, and be conveyed to the second generator via the second driven rotor.

According to an embodiment of the present technology, the at least one driving rotor may include a common rotor linked to both the first driven rotor and the second driven rotor. Note however, that in other embodiments, the at least one driving rotor does not have to include a common rotor. In this case, the at least one driving rotor may include a first driving rotor linked to the first driven rotor and a second driving rotor linked to the second driven rotor.

According to an embodiment of the present technology, the common rotor may be a bevel gear. Note however, that in other embodiments, the common rotor may be a spur gear, or may be a belt pulley.

According to an embodiment of the present technology, the input shaft of the first generator and the input shaft of the second generator may each be orthogonal to the drive shaft. Note however, that in other embodiments, the input shaft of the first generator and the input shaft of the second generator may be inclined with respect to the drive shaft.

According to an embodiment of the present technology, the input shaft of the first generator and the input shaft of the second generator may be disposed concentrically. Note however, that in other embodiments, the input shaft of the first generator and the input shaft of the second generator may be situated offset from each other.

According to an embodiment of the present technology, a rotation direction of the input shaft of the first generator as viewed from the drive shaft side and a rotation direction of the input shaft of the second generator as viewed from the drive shaft side may be the same as each other. According to such a configuration, the first generator and the second generator can be configured using identical generators. As a result, the productivity of the hydraulic power generation device can be improved.

In an embodiment of the present technology, the drive shaft may extend in a vertical direction from the water turbine. Note however, that in other embodiments, the drive shaft may extend in a horizontal direction from the water turbine.

According to an embodiment of the present technology, the drive shaft may extend downward following the vertical direction from the water turbine, and the first generator and the second generator may be situated downward from the waterway. According to such a configuration, for example, foreign matter discharged during operations of the first generator and the second generator can be suppressed from falling and entering the waterway.

### First Embodiment

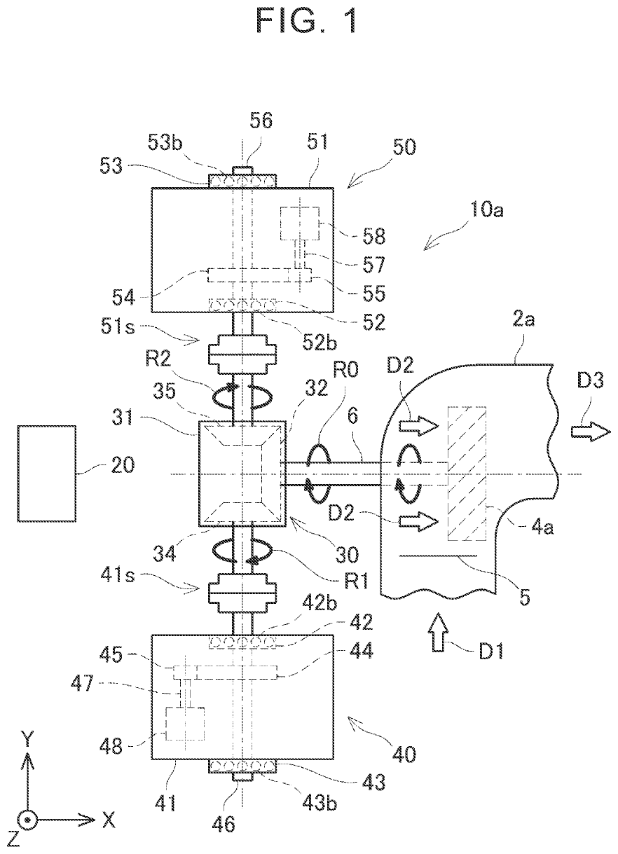

A hydraulic power generation device 10a according to a first embodiment will be described with reference to FIG. 1. The hydraulic power generation device 10a includes a water turbine 4a, a first generator 40, a second generator 50, a step-up gearbox 30 and a control device 20. The hydraulic power generation device 10a generates power by conveying rotation of the water turbine 4a to the generators 40 and 50 via the step-up gearbox 30. The hydraulic power generation device 10a controls the operations of the generators 40 and 50 by the control device 20. The control device 20 transmits the electric power generated by the generators 40 and 50 to an electric power system (omitted from illustration). Note that a positive side of a Z-axis direction in coordinate axes in the drawings indicates an upward direction in the vertical direction, and a negative side of the Z-axis direction in coordinate axes in the drawings indicates a downward direction in the vertical direction. Hereinafter, the positive side in the Z-axis direction may be simply referred to as “up”, and the negative side in the Z-axis direction may be simply referred to as “down”.

The water turbine 4a includes a drive shaft 6 extending in one direction from the water turbine 4a. The drive shaft 6 is a shaft fixed to the center of the water turbine 4a. The water turbine 4a is disposed in a waterway 2a. The waterway 2a curves from a positive side in a Y-axis direction (i.e., upward in the plane of the diagram in FIG. 1) toward a positive side in an X-axis direction (i.e., a right side in the plane of the diagram in FIG. 1). Further, the waterway 2a is bent downward (i.e., to a far side in the plane of the diagram in FIG. 1) at a step 5. Water in the waterway 2a flows to the positive side in the Y-axis direction, as indicated by arrow D1. Thereafter, the water in the waterway 2a falls at the step 5 toward the water turbine 4a. Further, the water in the waterway 2a flows toward the water turbine 4a, as indicated by arrow D2. The water in the waterway 2a passes through the water turbine 4a following guide vanes provided on the water turbine 4a, and flows in a direction of arrow D3. As a result, the water turbine 4a rotates. Thus, the water in the waterway 2a converts the energy that falls at the step 5 into rotation of the water turbine 4a. When the water turbine 4a rotates, the drive shaft 6 of the water turbine 4a also rotates along therewith. The drive shaft 6 is connected to a driving rotor 32 of the step-up gearbox 30.

The step-up gearbox 30 includes a case 31, the driving rotor 32, a first driven rotor 34, and a second driven rotor 35. The case 31 accommodates the rotors 32, 34, and 35. Each rotor 32, 34, and 35 is a bevel gear and has a pitch face. The pitch face of the driving rotor 32 is in contact with the pitch face of the first driven rotor 34. Accordingly, teeth of the pitch face of the driving rotor 32 mesh with teeth of the pitch face of the first driven rotor 34. As a result, the first driven rotor 34 is disposed orthogonally to the drive shaft 6 to which the driving rotor 32 is fixed. Similarly, the second driven rotor 35 also meshes with the driving rotor 32, in a state disposed orthogonally to the drive shaft 6. Thus, the driving rotor 32 is a common rotor linked to both the first driven rotor 34 and the second driven rotor 35. Accordingly, rotation of the drive shaft 6 extending from the water turbine 4a is conveyed to the first driven rotor 34 and the second driven rotor 35 disposed orthogonally to the drive shaft 6 via the single driving rotor 32. By conveying the rotation of the drive shaft 6 to the two rotors 34 and 35 via one driving rotor 32 in this way, the size of the step-up gearbox 30 can be reduced.

As illustrated in FIG. 1, the driving rotor 32 is rotated by the drive shaft 6 in a direction R0 (i.e., clockwise as viewed from the water turbine 4a side). As a result, the first driven rotor 34 rotates in a direction R1 (i.e., clockwise as viewed from the drive shaft 6 side), and the second driven rotor 35 rotates in a direction R2 (i.e., clockwise as viewed from the drive shaft 6 side).

The first driven rotor 34 and the second driven rotor 35 both have the same number of teeth. Further, the first driven rotor 34 and the second driven rotor 35 have the same outer diameter. That is, the first driven rotor 34 and the second driven rotor 35 are made up of identical bevel gears. As a result, a central axis of the first driven rotor 34 and a central axis of the second driven rotor 35 meshing with one driving rotor 32 are disposed concentrically with each other. Also, the number of teeth of the driving rotor 32 is greater than the number of teeth of the first driven rotor 34 and the number of teeth of the second driven rotor 35. As a result, the revolutions of the first driven rotor 34 and the second driven rotor 35 increase with respect to the revolutions of the driving rotor 32. Accordingly, the step-up gearbox 30 speeds up the rotation of the first driven rotor 34 and the rotation of the second driven rotor 35.

Thus, the step-up gearbox 30 distributes and conveys the rotation of the drive shaft 6 to the first driven rotor 34 and the second driven rotor 35, and speeds up the rotation input from the drive shaft 6 by the first driven rotor 34 and the second driven rotor 35. Hence, the size of the hydraulic power generation device 10a can be reduced by providing the step-up gearbox 30 with two functions. As a result, the degree of freedom in the layout of the hydraulic power generation device 10a can be further improved.

The first generator 40 includes a case 41, a first input shaft 46, a first motor 48, bearings 42 and 43, a first input gear 44, a motor gear 45, and a motor shaft 47. The case 41 accommodates the components of the first generator 40. The first input shaft 46 of the first generator 40 is a shaft that passes through the case 41. The first input shaft 46 is connected to the first driven rotor 34 of the step-up gearbox 30 via a shaft coupling joint 41s. As a result, the first input shaft 46 is disposed orthogonally with respect to the drive shaft 6. The rotation of the drive shaft 6 of the water turbine 4a in the direction R0 is conveyed through the driving rotor 32 and the first driven rotor 34 of the step-up gearbox 30 to the first input shaft 46 of the first generator 40 that is orthogonal to the drive shaft 6, as rotation in the direction R1.

The bearings 42 and 43, and the first input gear 44, are fixed to the first input shaft 46. The first input shaft 46 is rotatably supported on the case 41 by the bearings 42 and 43. The bearings 42 and 43 are both so-called ball bearings, each having a plurality of balls 42b and 43b.

The first input gear 44 is a so-called spur gear. The first input gear 44, and the motor gear 45 which is a spur gear, mesh with each other. The motor gear 45 is fixed to the motor shaft 47. Thus, rotation of the first input shaft 46 is conveyed to the motor shaft 47. As a result, a magnet (omitted from illustration) that is fixed to the motor shaft 47 rotates, and the first motor 48 generates electricity. Thus, the first generator 40 generates electricity using the rotation of the water turbine 4a.

The second generator 50 includes a case 51, a second input shaft 56, a second motor 58, bearings 52 and 53, a second input gear 54, a motor gear 55, and a motor shaft 57. The case 51 accommodates the components of the second generator 50. A second input shaft 56 is a shaft that passes through the case 51. The second input shaft 56 is connected to the second driven rotor 35 via a shaft coupling joint 51s. As a result, the second input shaft 56 is disposed orthogonally with respect to the drive shaft 6. The rotation of the drive shaft 6 of the water turbine 4a in the direction R0 is conveyed through the driving rotor 32 and the second driven rotor 35 of the step-up gearbox 30 to the second input shaft 56 of the second generator 50 that is orthogonal to the drive shaft 6, as rotation in the direction R2. That is to say, the direction R1 in which the first input shaft 46 of the first generator 40 rotates and the direction R2 in which the second input shaft 56 of the second generator 50 rotates are the same as each other as viewed from the drive shaft 6 (i.e., the input side). Thus, the second generator 50 has the same configuration as the first generator 40. Accordingly, the generators 40 and 50 can be configured as identical generators. As a result, production efficiency of the hydraulic power generation device 10a is improved.

Also, as described earlier, the central axis of the first driven rotor 34 and the central axis of the second driven rotor 35 are disposed concentrically, and accordingly the first input shaft 46 and the second input shaft 56 are disposed concentrically.

Thus, in the hydraulic power generation device 10a according to the present embodiment, the rotation of the drive shaft 6 extending in one direction from the water turbine 4a is distributed and conveyed to the generators 40 and 50 by the step-up gearbox 30. Thus, the degree of freedom of layout can be improved.

### Second Embodiment

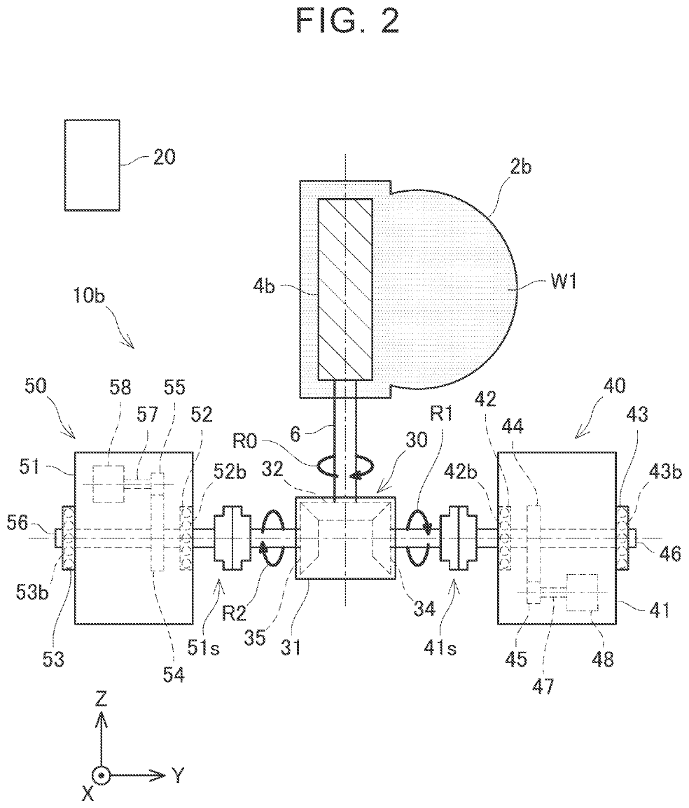

A hydraulic power generation device 10b according to a second embodiment will be described with reference to FIG. 2. FIG. 2 is a front view of the hydraulic power generation device 10b. The hydraulic power generation device 10b according to the second embodiment also includes the step-up gearbox 30 and the generators 40 and 50, in the same way as with the hydraulic power generation device 10a according to the first embodiment. However, in the hydraulic power generation device 10b according to the present embodiment, the layout of the components is changed as compared to the hydraulic power generation device 10a according to the first embodiment.

A waterway 2b is situated above the step-up gearbox 30 in the hydraulic power generation device 10b. In the waterway 2b, water W1 flows on the positive side in the X-axis direction (i.e., from the far side to the near side in the plane of the drawing in FIG. 2). Accordingly, a water turbine 4b rotates along with the drive shaft 6 in the direction R0. As a result, the driving rotor 32 of the step-up gearbox 30 also rotates in the direction R0. The step-up gearbox 30 distributes and conveys the rotation of the driving rotor 32 in the direction R0 to the driven rotors 34 and 35. This causes the input shafts 46, 56 to rotate in the directions R1 and R2, respectively. Thus, the hydraulic power generation device 10b according to the present embodiment also conveys the rotation of the drive shaft 6 to the generators 40 and 50 using the step-up gearbox 30, except that the drive shaft 6 vertically extends from the water turbine 4b. Disposing the hydraulic power generation device 10b below the waterway 2b further improves the degree of freedom in the layout of the hydraulic power generation device 10b. Further, foreign matter generated when the hydraulic power generation device 10b malfunctions can be suppressed from entering the waterway 2b.

### Third Embodiment

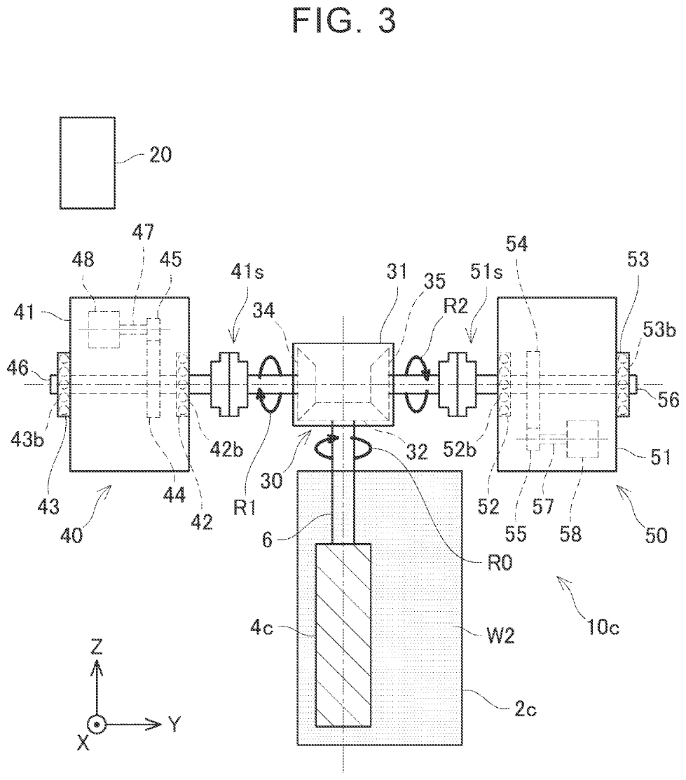

A hydraulic power generation device 10c according to a third embodiment will be described with reference to FIG. 3. The hydraulic power generation device 10c according to the third embodiment also includes the step-up gearbox 30 and the generators 40 and 50, in the same way as with the hydraulic power generation devices 10a and 10b described above, but the layout thereof is different. A waterway 2c of the hydraulic power generation device 10c is situated downward from the hydraulic power generation device 10c. In the waterway 2c, water W2 flows on the positive side in the X-axis direction (i.e., from the far side to the near side in the plane of the drawing in FIG. 3). Accordingly, a water turbine 4c rotates along with the drive shaft 6 in the direction R0. As a result, the driving rotor 32 of the step-up gearbox 30 also rotates in the direction R0. The step-up gearbox 30 distributes and conveys the rotation of the driving rotor 32 in the direction R0 to the driven rotors 34 and 35. This causes the input shafts 46, 56 to rotate in the directions R1 and R2, respectively. Thus, the hydraulic power generation device 10c according to the present embodiment also conveys the rotation of the drive shaft 6 to the generators 40 and 50 using the step-up gearbox 30, except that the drive shaft 6 vertically extends from the water turbine 4c. Disposing the hydraulic power generation device 10c above the waterway 2c further improves the degree of freedom in the layout of the hydraulic power generation device 10c. Employing the layout of the hydraulic power generation device 10c according to the third embodiment enables the hydraulic power generation device 10c to be used as an upright-type water turbine power generator for agricultural water, for example.

### Fourth Embodiment

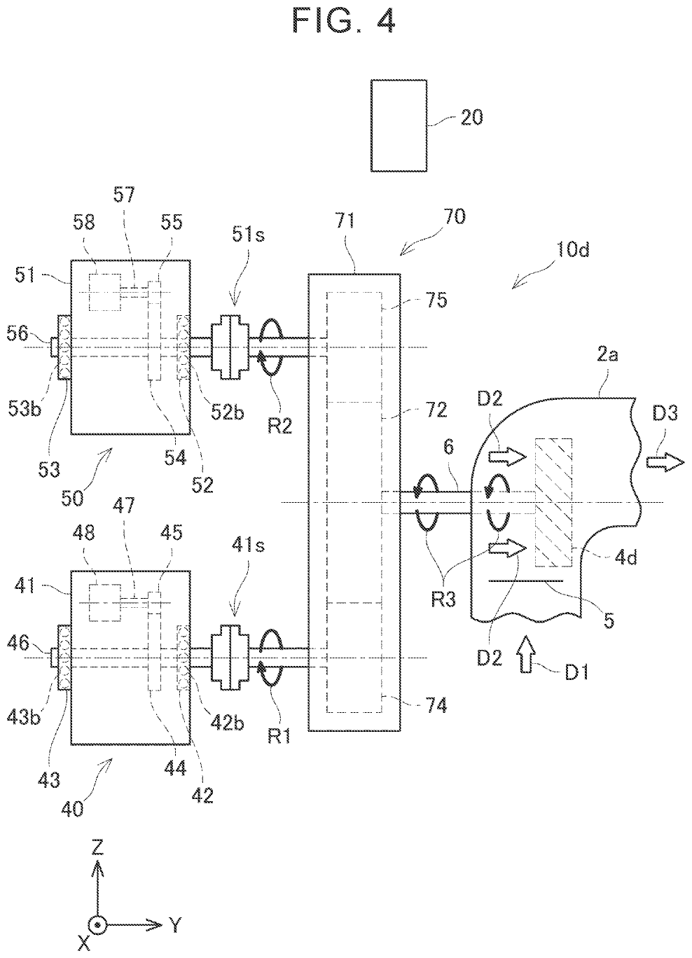

A hydraulic power generation device 10d according to a fourth embodiment will be described with reference to FIG. 4. The hydraulic power generation device 10d according to the fourth embodiment includes a water turbine 4d instead of the water turbine 4a according to the first embodiment. Further, the hydraulic power generation device 10d includes a step-up gearbox 70 instead of the step-up gearbox 30 according to the first embodiment. However, except for these points, the hydraulic power generation device 10d has the same configuration as the hydraulic power generation device 10a according to the first embodiment.

The water turbine 4d is equipped with guide vanes which are inclined in an opposite direction as those of the water turbine 4a according to the first embodiment, with respect to a central axis thereof. Accordingly, when the water in the waterway 2a flows following arrow D2, the water turbine 4d rotates in a direction R3 (i.e., counterclockwise as viewed from the water turbine 4d side). As a result, the drive shaft 6 fixed to the water turbine 4d also rotates in the direction R3. The drive shaft 6 is connected to a driving rotor 72 of the step-up gearbox 70.

The step-up gearbox 70 includes a case 71, the driving rotor 72, a first driven rotor 74, and a second driven rotor 75. The case 71 accommodates the rotors 72, 74, and 75. In the hydraulic power generation device 10d according to the fourth embodiment, each rotor 72, 74, and 75 is made up of a spur gear. The driving rotor 72 is fixed to the drive shaft 6. Accordingly, when the drive shaft 6 rotates in the direction R3, the driving rotor 72 also rotates in the direction R3. The driving rotor 72 meshes with each of the first driven rotor 74 and the second driven rotor 75. Accordingly, when the driving rotor 72 rotates in the direction R3, the first driven rotor 74 rotates in the direction R1 opposite to the direction R3 (i.e., clockwise as viewed from the water turbine 4d side), and the second driven rotor 75 rotates in the direction R2 opposite to the direction R3 (i.e., clockwise as viewed from the water turbine 4d side). That is to say, the directions R1 and R2 in which the driven rotors 74 and 75 rotate are the same as each other. Accordingly, the generators 40 and 50 can be configured as identical generators.

Also, the number of teeth of the driving rotor 72 is greater than the number of teeth of the first driven rotor 74 and the number of teeth of the second driven rotor 75. As a result, the revolutions of the first driven rotor 74 and the second driven rotor 75 increase with respect to the revolutions of the driving rotor 72. Accordingly, the step-up gearbox 70 speeds up the rotation of the first driven rotor 74 and the rotation of the second driven rotor 75.

### Fifth Embodiment

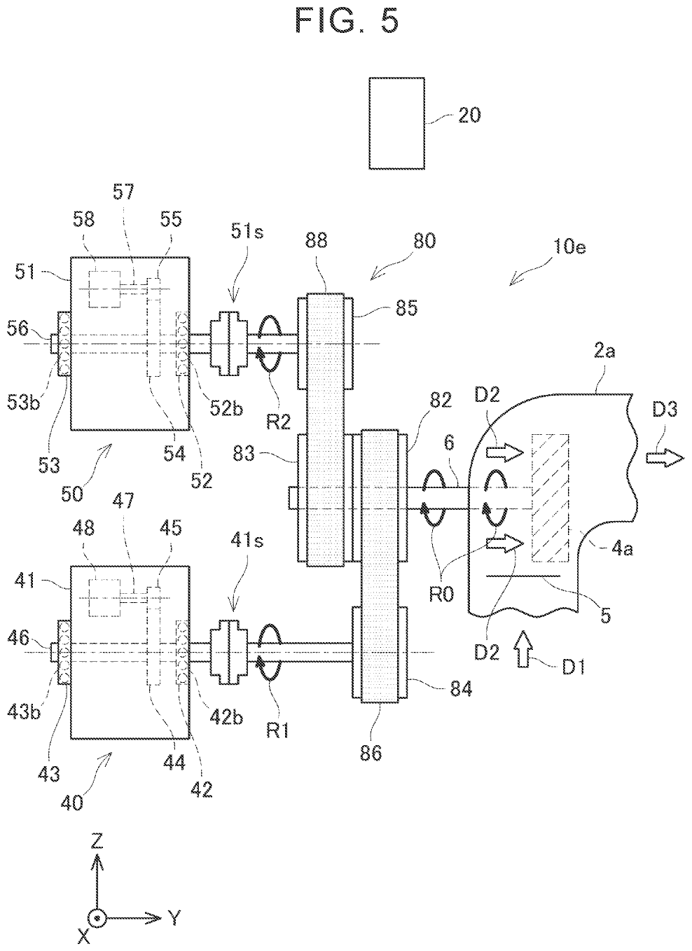

A hydraulic power generation device 10e according to a fifth embodiment will be described with reference to FIG. 5. The hydraulic power generation device 10e according to the fifth embodiment has the same configuration as the hydraulic power generation device 10a according to the first embodiment, except for the point that a step-up gearbox 80 is provided instead of the step-up gearbox 30 according to the first embodiment.

The step-up gearbox 80 according to the fifth embodiment includes a first driving rotor 82, a second driving rotor 83, a first driven rotor 84, a second driven rotor 85, a first belt 86, and a second belt 88. Each rotor 82 to 85 is made up of a belt pulley. Both driving rotors 82 and 83 are fixed to the drive shaft 6. The first belt 86 links the first driving rotor 82 and the first driven rotor 84. Thus, rotation of the first driving rotor 82 is conveyed to the first driven rotor 84. In the same way, the second belt 88 links the second driving rotor 83 and the second driven rotor 85. Thus, rotation of the second driving rotor 83 is conveyed to the second driven rotor 85.

Rotation of the drive shaft 6 in the direction R0 (i.e., clockwise as viewed from the water turbine 4a side) is conveyed to the first driven rotor 84 as rotation in the direction R1 (i.e., clockwise as viewed from the water turbine 4a side). In the same way, the rotation of the drive shaft 6 in the direction R0 is conveyed to the second driven rotor 85 as rotation in the direction R2 (i.e., clockwise as viewed from the water turbine 4a side). That is to say, the directions R1 and R2 in which the driven rotors 84 and 85 rotate are the same as each other. Accordingly, the generators 40 and 50 can be configured as identical generators.

Also, the diameters of the driving rotors 82 and 83 are larger than the diameters of the first driven rotor 84 and the second driven rotor 85. As a result, the revolutions of the first driven rotor 84 and the second driven rotor 85 increase with respect to the revolutions of the driving rotors 82 and 83. Accordingly, the step-up gearbox 80 speeds up the rotation of the first driven rotor 84 and the rotation of the second driven rotor 85.

Although specific examples of the technology disclosed in the present specification have been described above in detail, these are only exemplary, and do not limit the claims. The technology described in the claims includes various modifications and alterations of the specific examples described above. Modifications of the above embodiments are listed below.

### First Modification

The hydraulic power generation device 10d according to the fourth embodiment may include an intermediate rotor between the driving rotor 72 and the first driven rotor 74. In this case, the hydraulic power generation device 10d may include, instead of the first generator 40, a generator that generates power by rotating in a direction opposite to the first generator 40.

### Second Modification

In the embodiments described above, the hydraulic power generation device includes the first generator 40 and the second generator 50. In addition to this, a third generator and a fourth generator may further be included, in the present modification. In this case, the third generator and the fourth generator may be connected to a second drive shaft extending from the water turbine in the opposite direction to the drive shaft 6, for example.

The technical elements described in the present specification or illustrated in the drawings exhibit technical utility singularly or in various combinations, and are not limited to the combination described in the claims as filed. The technology described in the present specification or exemplified in the drawings may simultaneously achieve a plurality of objects, and exhibit technical utility by achieving one of the objects.

1. A hydraulic power generation device comprising:
a water turbine disposed in a waterway;
a drive shaft that extends to one side from the water turbine, the drive shaft being configured to rotate along with the water turbine;
a first generator;
a second generator; and
a conveying mechanism configured to convey rotation of the drive shaft to an input shaft of the first generator and an input shaft of the second generator.

2. The hydraulic power generation device according to claim 1, wherein the conveying mechanism is configured to convey the rotation of the drive shaft to the input shaft of the first generator and the input shaft of the second generator, by performing step-up of the rotation of the drive shaft.

3. The hydraulic power generation device according to claim 1, wherein the conveying mechanism includes:
at least one driving rotor fixed to the drive shaft;
a first driven rotor fixed to the input shaft of the first generator and linked to the at least one driving rotor; and
a second driven rotor fixed to the input shaft of the second generator and linked to the at least one driving rotor.

4. The hydraulic power generation device according to claim 3, wherein the at least one driving rotor includes a common rotor linked to both the first driven rotor and the second driven rotor.

5. The hydraulic power generation device according to claim 4, wherein the common rotor is a bevel gear.

6. The hydraulic power generation device according to claim 3, wherein the input shaft of the first generator and the input shaft of the second generator are each orthogonal to the drive shaft.

7. The hydraulic power generation device according to claim 3, wherein the input shaft of the first generator and the input shaft of the second generator are disposed concentrically.

8. The hydraulic power generation device according to claim 3, wherein a rotation direction of the input shaft of the first generator as viewed from a drive shaft side and a rotation direction of the input shaft of the second generator as viewed from the drive shaft side are the same as each other.

9. The hydraulic power generation device according to claim 1, wherein the drive shaft extends in a vertical direction from the water turbine.

10. The hydraulic power generation device according to claim 9, wherein:
the drive shaft extends downward following the vertical direction from the water turbine; and
the first generator and the second generator are situated downward from the waterway.
